(19) United States
(12) Patent Application Publication
(10) Pub. No.: US 2004/0120720 A1
(43) Pub. Date: Jun. 24, 2004

(54) Fiber optic transceiver with VCSEL source

(76) Inventors: Chin L. Chang, Walnut, CA (US); Amado Cordova, Venice, CA (US)

Correspondence Address: Elliott N. Kramsky, Esq., Suite 400, 5850 Canoga Avenue, Woodland Hills, CA, 91367, US

(21) Appl. No.: 10/329,225

(22) Filed: Dec. 24, 2002

(51) Int. Cl. H04B 10/00

(52) U.S. Cl. 398/139; 398/135

(57) ABSTRACT

A fiber optic transceiver includes a VCSEL light source. The transceiver is adapted to communicate with existing LED-based transceivers to enable external electronic circuits to interact. The transceiver of the invention includes an InGaAs photodetector for receiving 1310 nm signals emitted from the LED light source of an existing transceiver. The existing transceiver typically includes an InGaAs photodetector characterized by distinct responsivities at 850 nm and at 1310 nm. This enables signals transmitted at 850 nm from the VCSEL light source of the transceiver to be detected by an existing LED-based transceiver, while the InGaAs photodetector of the transceiver of the invention is capable of receiving signals emitted from the LED light source.

### BACKGROUND

1. Field of the Invention

The present invention relates to fiber optic transceivers. More particularly, this invention pertains to a fiber optic transceiver employing a transmitter based on a vertical cavity surface emitting laser (“VCSEL”).

2. Description of the Prior Art

Fiber optic transceivers are widely employed throughout systems that require the transfer of data or voice over optical fibers and are the last opto-electronic interface between the electronic processing circuits and the optical fiber. Such devices are currently employed, for example, in telecommunications, storage and computer networks, industrial automation, digital video transmission and the like.

FIG. 1 is a block diagram that illustrates the communication of information between a pair of fiber optic transceivers 10 and 12. The first transceiver 10 forms the interface between an external electronic circuit 14 and a remote arrangement comprising the second transceiver 12 and its external electronic circuit 16. Each of the transceivers 10 and 12 is typically mounted on a printed circuit board.

Each transceiver both receives and transmits optical signals. The transmitted optical signals are modulated, in each case, by the activity of the associated external electronic circuit 14 and 16 respectively while the received optical signals are detected and converted into electrical signals for demodulation and processing by the external electronic circuits. Both types of signals are transmitted through optical fibers 18 and 20.

The ubiquity of transceivers in present-day systems demands that such devices provide economy, both in design and power consumption. Low power consumption also permits the aggregation of numerous transceivers into a limited space. This situation becomes more critical as circuits are added to existing systems to enhance capabilities.

Transceivers are typically optimized to operate at specific data rates and wavelengths. Currently, standard industry data rates vary from 155 Mbps (for OC-3) to 2.48 Gbps (for OC-48) while the light sources for transceivers include Fabry-Perot and Distributed Feedback lasers that operate at around 1310 nm or 1550 nm, Vertical Cavity Surface Emitting Lasers (VCSEL) that operate at around 850 nm and Light Emitting Diodes (LED) which operate at around 1310 nm.

Numerous fiber optic transceivers communicate over multimode fiber. Such communication may take place over distances ranging from a few meters to a maximum of two kilometers at relatively “slow” data rates (e.g. 155 Mbps). The vastly preferred transceiver configuration for such applications involves an LED light source coupled with an InGaAs (indium gallium arsenide) photodetector. Such configuration is preferred in view of the relatively low cost of the LED light source and, for this reason, has become an unofficial standard or “legacy” transceiver for such applications.

Fiber optic transceivers based upon VCSEL light sources have proven to provide significant advantages over LED light source-based transceivers. Typically, a VCSEL requires only one-tenth of the current of a LED and is capable of providing twenty times the optical power while offering greater long-term reliability. In addition, the transfer function (optical power versus electrical current) of a VCSEL is linear whereas that of an LED quickly saturates (reaches a plateau) at higher currents. This results in significantly easier optical power tracking with a VCSEL than with a LED. To date, fiber optic transceivers employing VCSEL as light source have employed photodetectors based on silicon (Si) or gallium arsenide (GaAs) as each of such materials exhibits maximum responsivity R (ratio of generated photocurrent (in, e.g., amperes) to input optical optical power (in e.g. watts)) at around 850 nm, the wavelength of peak optical energy output by a VCSEL source.

As mentioned earlier, the LED light source-based fiber optic transceiver has gained a significant foothold over the years over a vast range of popular applications. While the VCSEL is highly advantageous for numerous reasons, including those set forth above, the vast acceptance of LED-based transceivers in the past has severely limited the ability to incorporate VCSEL light source-based transceivers into existing systems as these transceivers operate at significantly differenct wavelengths. Additionally, the relatively-high optical power losses per meter of optical fiber at the wavelength of peak optical power output of VCSEL light sources (i.e. 850 nm) has provided a further deterrent to the widespread adoption of VCSEL-based fiber optic transceivers.

### SUMMARY OF THE INVENTION

The preceding and other shortcomings of the prior art are addressed by the present invention that provides, in a first aspect, and improvement in a fiber optic transceiver for providing remote communication between an associated external electronic circuit and a second, remote fiber optic transceiver of the legacy type that includes an associated remote electronic circuit, over optical fibers. The fiber optic transceiver is of the type that includes a transmitter section having a light source and a receiver section having a photodetector.

The improvement provided by the invention includes the light source being a VCSEL and the photodetector being responsive to light of wavelength of about 1310 nm

In a second aspect, the invention provides an electronic system. The system includes a first electronic circuit arranged to receive an input electrical signal and to generate an output electrical signal in response. A first fiber optic transceiver is associated with the first electronic circuit and has a transmitter section that includes a light source for generating an optical signal in response to the output electrical signal generated by the first electronic circuit and a receiver section that includes a photodetector for receiving an optical signal from a remote transceiver and generating the input electrical signal for the first electronic circuit.

A second electronic circuit is arranged to receive an input electrical signal and to generate an output electrical signal in response. A second fiber optic transceiver is associated with the second electronic circuit, the second fiber optic transceiver having a transmitter section that includes a light source for generating an optical signal in response to the output electrical signal generated by the second electronic circuit and a receiver section that includes a photodetector for receiving an optical signal from a remote transceiver and generating said input electrical signal for the second electronic circuit.

The light source of said first transceiver is a LED and that of the second transceiver is a VCSEL. The photodetector of the first transceiver is responsive to light of wavelength of about 850 nm and that of the second transceiver is responsive to light of wavelength of about 1310 nm

In a third aspect, the invention presents a method for adapting a first electronic circuit to interact with a remote second electronic circuit where the second electronic circuit is associated with a fiber optic transceiver of the type that includes a LED light source and a photodetector responsive to light of about 850 nm wavelength.

The method is begun by associating a fiber optic transceiver having a VCSEL light source and a photodetector with the first electronic circuit. Thereafter, a first optical signal responsive to an output of the first electronic circuit is transmitted from the VCSEL light source to the photodetector of the second fiber optic transceiver over a first optical fiber. A second optical signal responsive to an output of the second electronic circuit is transmitted from the LED light source to the photodetector of the first fiber optic transceiver over a second optical fiber.

In a fourth aspect, the invention provides a fiber optic transceiver. The transceiver includes a transmitter section that includes a VCSEL light source and a receiver section that includes a photodetector responsive to light of wavelength of about 1310 nm

The above and other features of the invention will become further apparent from the detailed description that follows. Such description is accompanied by a set of drawing figures. Numerals of the drawing figures, corresponding to those of the written description, point to the features of the invention with like numerals referring to like features throughout both the written description and the drawing figures.

### BRIEF DESCRIPTION OF THE DRAWING FIGURES

FIG. 1 is a block diagram for illustrating the communication of information between a pair of fiber optic transceivers;

FIG. 2 is a schematic view of a fiber optic transceiver;

FIG. 3 is a block diagram including simplified representations of a fiber optic transceiver in accordance with the invention, a conventional LED-based “legacy” transceiver and indicating their interconnection for communication therebetween;

FIGS. 4(a) and 4(b) are graphs of responsivity as a function of the wavelength of input light for representative InGaAs photodetectors;

FIG. 5 is a table for comparing the optical performance of a communication link comprising an LED light source and an InGaAS photodetector with that of a communication link comprising a VCSEL light source and an InGaAs photodetector; and

FIGS. 6(a) and 6(b) are graphs of optical power versus power consumption for VCSEL and LED light sources, respectively.

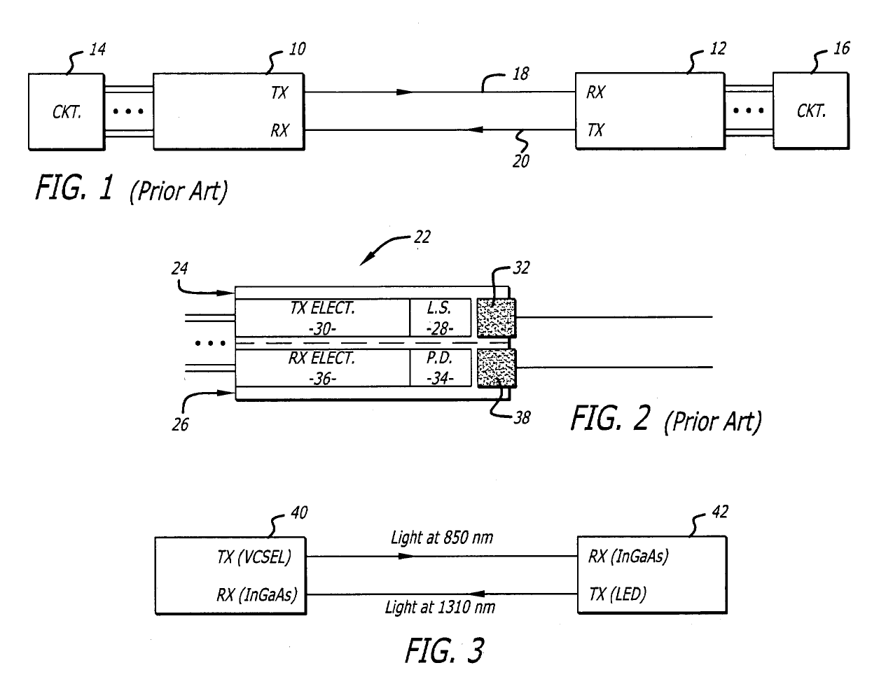

### DETAILED DESCRIPTION OF THE PREFERRED EMBODIMENT

FIG. 2 is a schematic view of a fiber optic transceiver 22. The transceiver 22 includes a transmitter section 24 and a receiver section 26. The transmitter section 24 contains a light source 28 and transmitter electronics circuitry 30 for (1) driving the light source 28 and (2) receiving modulation and control signals from an external electronic circuit (not shown).

The light source 28 is mounted in a so-called transmitter optical sub-assembly (“TOSA”) that interfaces directly with a first fiber optic ferrule connector 32. Transceivers are often identified by the type of optical connector employed. Different families of transceivers employ different optical connectors, with the main families of transceivers currently utilized being: SC-Duplex (SC fiber optic connectors); GBIC (SC duplex connectors); ST-Duplex (ST fiber optic connectors); SFF or Small Form Factor (LC connectors); SFP or Small Form Factor Pluggable (LC connectors); MT-RJ (MT-RJ connectors); MTP (MTP connectors). Additionally, different electrical connections are employed in different families of transceivers and this factor further contributes to the nomenclature of their identification. For example, 1×9 SC Duplex refers to a transceiver family having nine (9) such connections or pins, 2×5 SFF refers to a transceiver family of ten (10) such connections arranged into two rows, each of five pins, and 2×10 SFF refers of a transceiver family of twenty (20) connections arranged into two rows, each of ten pins.

The receiver section 26 of the transceiver 22 contains a photodetector 34 and receiver circuitry 36 required to amplify a received signal and to convert it to a signal suitable for delivery to the external electronic circuit. Such receiver circuitry 36 typically includes (1) a transimpedance amplifier that converts photodetector current into voltage and amplifies it and (2) a post amplifier. The photodetector 34 is typically mounted in a so-called receiver optical sub-assembly (“ROSA”) that interfaces directly with a second fiber optic ferrule connector 38.

As mentioned above, the design of a transceiver for use in an existing system must be compatible with the legacy transceivers of the existing system. A very common type of transceiver found in such systems employs a LED light source at the TOSA and an InGaAs photodetector at the ROSA. Such a configuration has gained wide acceptance due to the relatively low cost of the LED light source which outputs light of wavelength about 1310 nm While offering low initial cost, the LED light source is a high current, high electrical power consumption device subject to generating relatively high operating temperatures.

FIG. 3 is a block diagram including simplified representations of a fiber optic transceiver 40 in accordance with the invention, a conventional legacy LED-based transceiver 42 and indicating their interconnection for communication therebetween. External electronic circuits associated with the transceivers 40 and 42 are not included for purposes of clarity. As can be seen the transceiver 40 of the invention is configured with a VCSEL light source and an InGaAs photodetector. It functions in coordination with the legacy LED-based transceiver 42 as a hybrid arrangement. That is, while the VCSEL light source of the transceiver 40 outputs light of wavelength of about 850 nm, the associated InGaAs photodetector is capable of detecting the approximately 1310 nm wavelength light emitted by the LED light source of the legacy transceiver 42, eliminating the wavelength compatibility problem of LED and VCSEL-based transceivers.

The foregoing arrangement, providing communication between the VCSEL-based transceiver 40 of the invention and a conventional legacy LED-based transceiver 42 greatly enhances the range of applications, and thereby the utility, of a VCSEL-based transceiver, enabling one to realize significant advantages offered by a transceiver having such a source, as opposed to a high electrical power consumption LED light source. Previously, it was not thought that a transceiver including a VCSEL light source could be integrated into systems based upon LED-based legacy transceivers due to the different wavelengths of light that the two light sources emit.

The inventors have found and confirmed that a useful VCSEL-based transceiver in accordance with the transceiver 40 of the invention can interact with a legacy transceiver 42 as illustrated above despite the significantly different wavelengths of light emitted by the two types of light sources. Accordingly, the numerous benefits, discussed, of a VCSEL light source, including low power consumption and heating which permit the grouping of numerous transceivers into a given working space, can be incorporated into existing systems that employ legacy transceivers by employing a transceiver in accordance with the invention. By permitting the grouping of numerous transceivers into close proximity, the invention thereby permits the integration of additional electronic circuitry, and, therefore, additional operations and functions, into existing systems while, at the same time, reducing the power consumption of the overall system.

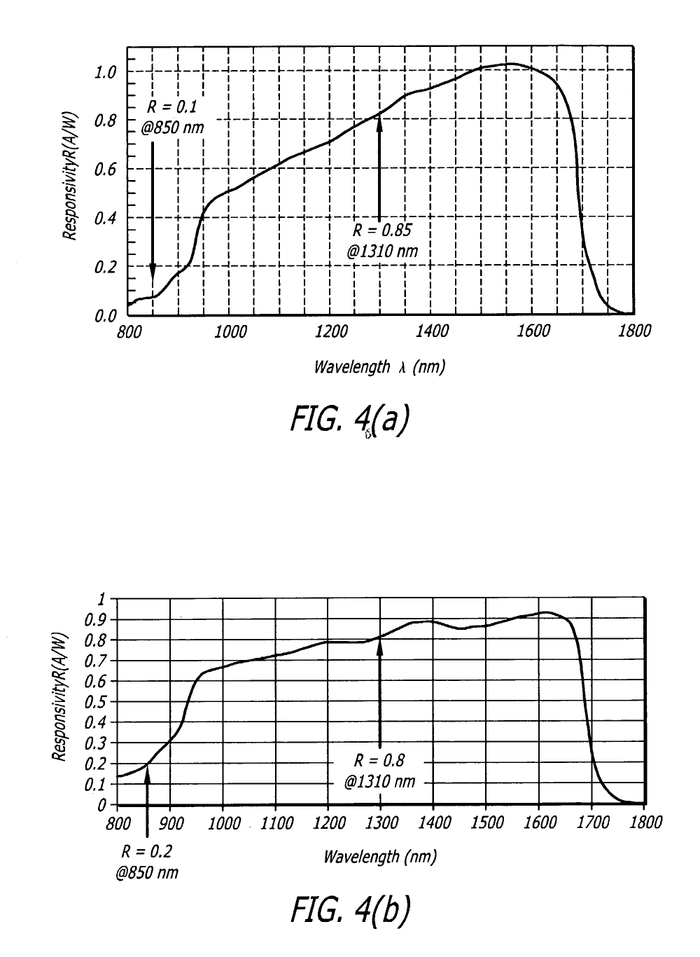

FIGS. 4(a) and 4(b) are graphs of responsivity R (amperes/watt) as a function of the wavelength of input light for representative InGaAs photodetectors. As mentioned above, such a photodetector is commonly found in a legacy transceiver operating at about 1310 nm The inventors have found that, while the utility of InGaAs photodetectors for the detection of optical energy at the frequently employed wavelengths of 1310 nm and 1550 nm is readily appreciated and witnessed by the incorporation of InGaAs photodetectors into systems that include Fabry Perot (FP) and Distributed Feedback (DFB) lasers (1310 nm and 1550 nm wavelengths) in addition to those that include LEDs, the viability of such a photodetector at 850 nm, the wavelength of light emitted by a VCSEL, has been neither appreciated not utilized.

The graphs of FIGS. 4(a) and 4(b) plot the responsivity of an InGaAs photodetector to light of wavelength ranging from 800 nm to 1800 nm InGaAs material exhibits a small non-negligible responsivity at 850 nm although the exact responsivity profile of such material may vary slightly from sample to sample or manufacturer to manufacturer as by comparison of the graphs of FIGS. 4(a) and 4(b). (Note: the responsivity of the material of FIG. 4(a) is half that of that of FIG. 4(b) at 850 nm) Such variation can readily compensated by design of the transceiver-to-transceiver transmission link for the worst-case scenario corresponding to lowest responsitivity. Such design practice is described below. Thus, the possibility of interfacing a VCSEL light source that emits 850 nm wavelength light with an InGaAs receiver can be appreciated.

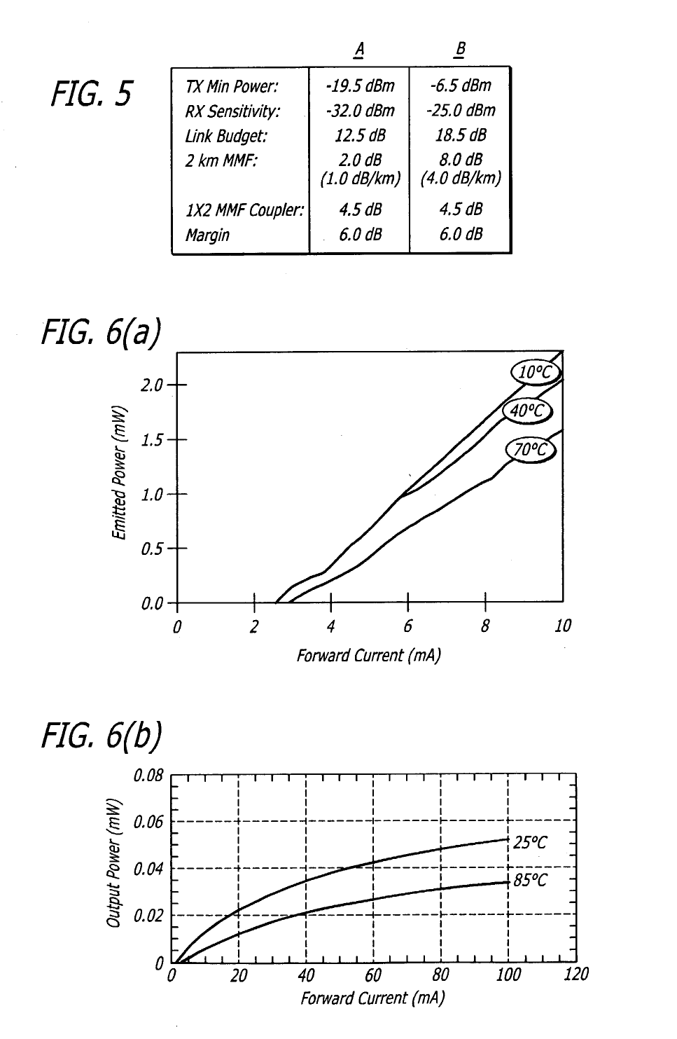

The inventors have further found that, due to a number of additional factors, a VCSEL transceiver in accordance with the invention is not only a theoretical possibility but, in fact can be configured to interface quite well with a legacy transceiver. FIG. 5 is a table that compares the optical performance of a communication link comprising a LED light source and an InGaAs receiver, as in the case of the transmission of an optical signal of wavelength 1310 nm between two legacy transceivers over two kilometers of optical fiber (column A) with that of a communication link comprising a VCSEL light source and an InGaAs receiver. The latter case, tabulated at column B, represents light of wavelength 850 nm transmitted over the same distance (2 kilometers) and received at an InGaAs photodetector.

The most important performance characteristic of a fiber optic link im modern digital communications is the maximum bit error rate (“BER”). Different communications standards (e.g., SONET/SDH, ATM, Ethernet) establish a maximum BER for a particular data rate. For example, the SONET/SDH standard requires maximum BER of 10exp(−10) or a single bit error within a transmitted sequence of 10exp(10) bits at OC-3 rates (155 Mbps). In general, the BER decreases with increased optical power impinging on the photodetector. This leads to the very important concept of Receiver (RX) Sensitivity, which is defined as the minimum optical power impinging on the photodetector such that the BER does not exceed the maximum specified by the standards. Thus, to compare the optical performances of “pure” LED and “mixed” LED/VCSEL optical fiber communication links, the sensitivities of the receivers are measured to assure that the requisite minimum is met. Thereafter, link budget margins of the two links are compared with comparisons performed under “worst-case” conditions. (Note: worst-case refers to consideration of the minimum power available from the light sources and maximum losses exhibited by the optical components and optical fiber.)

The receiver sensitivities of columns A and B differ as the receivers, each of which has an InGaAs photodetector, operate at different wavelengths. Moreover, the receiver sensitivity at 850 nm is 7 dB higher than that at 1310 nm This means that 7 dB more of detected optical power is needed to avoid exceeding the maximum BER. As long as the received optical powers exceed the two values (−32 dBm at 1310 n.m, and −25 dBm at 850 nm) such requirement is met.

Referring first to the pure legacy transceiver-to-legacy transceiver example of column A, “TX Min. Power” refers to the minimum opuput power of an LED source (−19.5 dBm). The difference between the TX Min. Power and the RX Sensitivity, the “Link Budget”, represents the excess optical power emitted from the LED light source for activating a InGaAs photodetector to generate an electrical signal for the external circuit assuming that the transmitter and the photodetector are adjacent one another (12.5 dBm). The Link Budget is reduced by the presence of lossy elements between the transmitter and the photodetector. In the example illustrated in FIG. 5, the transmitter and the photodetector are assumed to be separated by 2 kilometers of multimode optical fiber and a 1×2 optical coupler of multimode fiber is assumed. Both the fiber and the coupler are lossy and this is well understood to be a function of the wavelength of the light. Assuming 1.0 dB/km loss at 1310 nm, the light emitted from the LED source experiences a 2.0 dB loss in traveling through 2 kilometers of multimode fiber, reducing the Link Budget by this amount. Likewise, the 1×2 multimode fiber coupler is assumed to reduce the link budget of the 1310 nm light by 4.5 dB, and leaving a “Margin”, indicating the amount of power reaching the InGaAs photodetector in excess of the minimum required to produce a usable electrical signal output, of 6.0 dB.

Comparing the figures of column B with those of column A, it can be noted that, in the case of transmission from an 850 nm VCSEL light source to a legacy transceiver having an InGaAs photodetector, the following distinctions can be noted (in addition to the very important distinction that −25 dBm (as opposed to −32 dBm) or more optical power must reach the photodetector): the output optical power of a VCSEL transmitter significantly exceeds that of an LED light source (−6.5 dBm as opposed to −19.5 dBm). Due to the significantly greater power output of a VCSEL light source (twenty times that of the output of a LED), the Link Budget is higher (18.5 dB) for signal transmission from a VCSEL light source to an InGaAs receiver than it is for transmission between a pair of legacy transceivers (12.5 dB).

As noted in the table of FIG. 5, multimode optical fiber is, at worst, four times as lossy for 850 nm light than for 1310 nm light (4.0 dB/km versus 1.0 dB/km). Over a distance of 2 kilometers, the maximum useful range of an LED light source over multimode fiber, this increases losses from 2.0 dB to 8.0 dB, a 6.0 dB increase resulting in a 6.0 dB decrease in Link Budget. However, due to the significantly greater optical power output of a VCSEL light source, discussed above, this increased loss only offsets the excess of the Link Budget of column B over that of column A. As the loss due to the presence of a 1×2 multimode fiber coupler is the same for 850 nm and 1310 nm light, it is seen that, the side-by-side examples of columns A and B yield identical Margin values. Fiber optic system design requires a link budget margin to account for unforeseen system losses such as those due to connectors, temperature sensitivities, etc. The fact that the link budget margins of columns A and B of FIG. 5 are identical demonstrates, first, that the receiver sensivities, and therefore the BER, is met in each case and, secondly, that designers can count on the same margin for unforeseen losses, essentially rendering the two arrangements interchangeable.

A significant advantage of a VCSEL-based transceiver over a LED-based transceiver resides, as above-stated, in the significantly lower power consumption of a VCSEL light source. FIGS. 6(a) and 6(b) present graphs of optical power versus forward current of VCSEL and LED sources respectively. Since the electrical power consumption is directly proportional to the forward current, these graphs provide a means for comparison of electrical power consumption of a VCSEL with that of a LED. As can be seen, the current-optical power characteristic is somewhat temperature-dependent for each type of device and curves include data taken at differing temperatures for the two types of devices. A comparison of the two graphs clearly illustrates significantly lower forward (operating) electrical current consumption for a VCSEL light source than for a LED light source. This is reflected in the fact that the current scale of the graph of FIG. 6(a) is one-tenth that of the graph of FIG. 6(b) while the optical power scale of the graph of FIG. 6(a) is twenty-five times that of FIG. 6(b). Further, the approximate linearity of the graph of FIG. 6(a) versus that of FIG. 6(b) illustrates the greater controllability of a VCSEL light source.

By applying the teachings of the present invention, one may take advantage of the low electrical power consumption of a VCSEL light source in operation, enabling the packaging of additional circuitry within limited space and offering additional operational capabilities within existing systems.

The present invention, which provides a hybrid arrangement, is readily capable of interfacing, and thereby being incorporated into existing systems that include conventional LED-based fiber optic transceivers. Such versatility was previously thought to be impossible and LED-based transceivers believed to be limited to interaction with transceivers that operated at around 1310 nm As can be seen, a VCSEL light source is in many significant ways superior to a LED source and the present invention thus enables existing systems to take advantage of significant enhancements.

While the invention has been disclosed with reference to its presently-preferred embodiment, it is not limited thereto. Rather, this invention is limited only insofar as it is defined by the following set of patent claims and includes within its scope all equivalents thereof.

What is claimed is:

1. In a fiber optic transceiver for providing remote communication between an associated external electronic circuit and a second, remote fiber optic transceiver of the legacy type having an associated remote electronic circuit, over optical fibers, said fiber optic transceiver being of the type that includes a transmitter section having a light source and a receiver section having a photodetector, the improvement comprising, in combination:
a) said light source being a VCSEL; and
b) said photodetector being responsive to light of wavelength of about 1310 nm

2. A fiber optic transceiver as defined in claim 1 wherein said photodetector is of InGaAs.

3. An electronic system comprising, in combination:
a) a first electronic circuit arranged to receive an input electrical signal and to generate an output electrical signal in response thereto;
b) a first fiber optic transceiver associated with said first electronic circuit, said first fiber optic transceiver having a transmitter section including a light source for generating an optical signal in response to the output electrical signal generated by said first electronic circuit and a receiver section including a photodetector for receiving an optical signal from a remote transceiver and generating said input electrical signal for said first electronic circuit;
c) a second electronic circuit arranged to receive an input electrical signal and to generate an output electrical signal in response thereto;
d) a second fiber optic transceiver associated with said second electronic circuit, said second fiber optic transceiver having a transmitter section including a light source for generating an optical signal in response to the output electrical signal generated by said second electronic circuit and a receiver section including a photodetector for receiving an optical signal from a remote transceiver and generating said input electrical signal for said second electronic circuit;
e) said light source of said first transceiver being a LED and said light source of said second transceiver being a VCSEL; and
f) said photodetector of said first transceiver being responsive to light of wavelength of about 850 nm and said photodetector of said second transceiver being responsive to light of wavelength of about 1310 nm

4. An electronic system as defined in claim 3 wherein:
a) said LED light source of said first fiber optic transceiver communicates with said photodetector of said second fiber optic transceiver over a first multimode optical fiber; and
b) said VCSEL light source of said second fiber optic transceiver communicates with said photodetector of said first fiber optic transceiver over a second multimode optical fiber.

5. An electronic system as defined in claim 3 wherein said photodetector of said first fiber optic transceiver is of InGaAs.

6. An electronic system as defined in claim 5 wherein said photodetector of said second fiber optic transceiver is of InGaAs.

7. A method for adapting a first electronic circuit to interact with a remote second electronic circuit wherein said second electronic circuit is associated with a fiber optic transceiver of the type that includes a LED light source and a photodetector responsive to light of about 850 nm wavelength, said method comprising the steps of:
a) associating a fiber optic transceiver having a VCSEL light source and a photodetector with said first electronic circuit; then
b) transmitting a first optical signal responsive to an output of said first electronic circuit from said VCSEL light source to said photodetector of said second fiber optic transceiver over a first optical fiber; and
c) transmitting a second optical signal responsive to an output of said second electronic circuit from said LED light source to said photodetector of said first fiber optic transceiver over a second optical fiber.

8. A method as defined by claim 7 wherein each of said first and second optical fibers comprises multimode fiber.

9. A method as defined in claim 7 wherein each of said first and second optical fibers is no longer than 2 k.m.

10. A method as defined in claim 7 wherein each of said photodetectors of said first and said second fiber optic transceivers is of InGaAs.

11. A fiber optic transceiver comprising, in combination:
a) a transmitter section including a VCSEL light source; and
b) a receiver section including a photodetector responsive to light of wavelength of about 1310 nm

12. A fiber optic transceiver as defined in claims 11 wherein said photodetector is InGaAs.
